(19) United States
(12) Patent Application Publication
(10) Pub. No.: US 2020/0399072 A1
(43) Pub. Date: Dec. 24, 2020

(54) A CART ASSEMBLY FOR A CONVEYING DEVICE

(71) Applicant: Tetra Laval Holdings & Finance S.A., Pully (CH)

(72) Inventors: Fabio RICCI CURBASTRO, Ozzano dell' Emilia, Bologna (IT); Richard John PEDRETTI, Formigine (IT)

(73) Assignee: Tetra Laval Holdings & Finance S.A., Pully (CH)

(21) Appl. No.: 16/968,432

(22) PCT Filed: Feb. 15, 2019
(86) PCT No.: PCT/EP2019/053768

§ 371 Date: Aug. 7, 2020

(30) Foreign Application Priority Data
Feb. 19, 2018 (EP) 18157356.9

(51) Int. Cl. B65G 35/06; B65B 9/12; B65B 9/20; B65B 51/30

(52) U.S. Cl. CPC B65G 35/06; B65B 51/30; B65B 9/20; B65B 9/12

(57) ABSTRACT

A cart assembly for a conveying device comprises a body element, movable along a conveying path, and at least one tool carried by the body element between an operative position, in which the tool performs an operation on an article, and an idle position, in which the tool is in a stand-by condition; and a guide mechanism configured to allow the tool movement with respect to the body element. The guide mechanism comprises two first guide elements, extending parallel to a given direction, and one second guide element, also extending parallel to the direction and interposed between the first guide elements. The first and second guide elements are slidably coupled to permit relative movement along the direction of the second guide element relative to the first guide elements or vice versa; the second guide element has opposite lateral surfaces parallel to the direction cooperating in contact with both respective first guide elements.

### TECHNICAL FIELD

The present invention relates to a cart assembly for a conveying device. The conveying device may be part of a packaging apparatus configured to form and seal a plurality of packs containing a pourable food product, or may be part of a capping apparatus for capping said packs.

### BACKGROUND ART

Conveying devices are known, which are provided with one or two tracks along which respective pluralities of cart assemblies cyclically move at very high speed.

In the known configurations, the cart assemblies are movable independently from one another along the respective track.

For achieving such independent movement, linear motors are typically used: in this case, the track is equipped with a plurality of electric coils, which, in a well-known manner, independently control the movement of each cart assembly, the latter being provided with corresponding permanent magnets.

Each cart assembly is typically provided with a body element and one or more tools carried in a movable manner by the body element itself and configured to perform certain operations on one or more given articles.

Generally, the tools are movable, with respect to their respective body element and by means of actuators, e.g. cam devices, between an operative position, in which the tools perform said operations on the article(s), and an idle position, in which the tools are in a stand-by condition.

For example, in the case in which the conveying device is part of a packaging apparatus configured to form and seal a plurality of pillow packs starting from a tube of packaging material, each cart assembly is provided with a forming unit and a sealing unit, i.e. a pair of tools, cyclically movable between:
an idle position, or open position, in which they are detached from the tube; and
an operative position, or closed position, in which they contact the tube to define and control the volume of the packs being formed, and to seal each pack at equally spaced, consecutive transversal cross sections.

Typically, each cart assembly is further provided with one or more guide mechanisms configured to allow a precise movement of respective tools between their idle positions and operative positions.

A need is felt in the industry to minimize the number of components of such guide mechanisms, thereby providing compact configurations of the same, though maintaining high precision and accuracy.

### DISCLOSURE OF INVENTION

It is therefore an object of the present invention to provide a cart assembly, which is designed to meet the above-mentioned need in a straightforward and low-cost manner.

This object is achieved by a cart assembly as claimed in claim 1.

### BRIEF DESCRIPTION OF THE DRAWINGS

A preferred, non-limiting embodiment of the present invention will be described by way of example with reference to the accompanying drawings, in which:

FIG. 1 is a perspective view, with parts removed for clarity, of two cart assemblies made according to the teachings of the present invention and movable along respective tracks;

FIG. 2 is a larger-scale, perspective view of the cart assemblies of FIG. 1;

FIGS. 3 to 5 are schematic, partially sectioned top views, with parts removed for clarity, of a guide mechanism of one of the cart assemblies of FIG. 1 during different and consecutive operating conditions;

FIGS. 6 and 7 are schematic, partially sectioned top views of the guide mechanism of FIG. 3 showing details of the same;

FIG. 8 is a larger-scale section along line VIII-VIII of FIG. 3, with parts removed for clarity; and

FIGS. 9 and 10 are two different perspective views of the guide mechanism of FIG. 3, with parts removed for clarity.

### BEST MODE FOR CARRYING OUT THE INVENTION

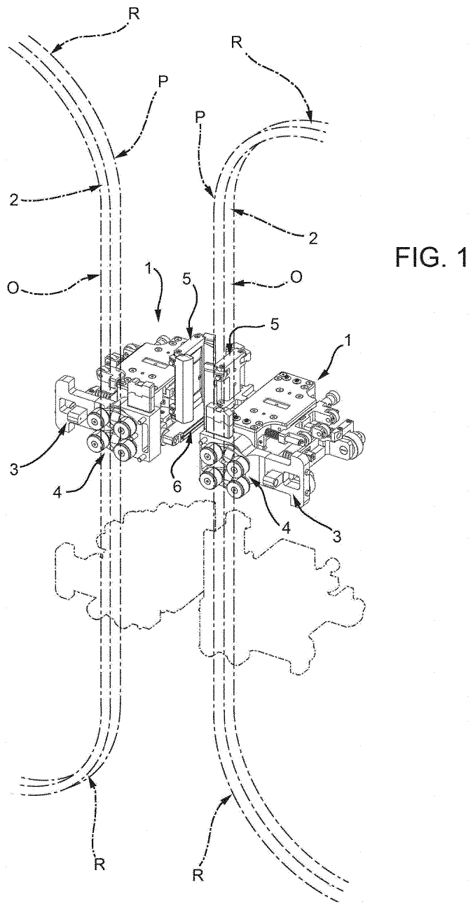

With reference to FIG. 1, number 1 indicates as a whole a cart assembly for a conveying device.

In particular, the conveying device is provided with a pair of facing endless tracks 2 (only schematically shown) arranged at opposite lateral sides thereof, and is configured to advance a plurality of cart assemblies 1 along each track 2.

More specifically, each cart assembly 1 moving on one track 2 cooperates with the corresponding cart assembly 1 moving on the other track 2, defining in this way a pair of cooperating cart assemblies 1.

In FIG. 1, a pair of such cooperating cart assemblies 1 is illustrated. Each cart assembly 1 substantially comprises a body element 3 cooperating in sliding manner with the respective track 2, preferably by means of a plurality of wheels 4.

In particular, each body element 3 is cyclically movable along the respective track 2 of the conveying device. In this way, each track 2 defines a respective conveying path P for each body element 3 and, thus, for each cart assembly 1 moving thereon.

Preferably, the conveying device is of linear motor type, so that cart assemblies 1 are cyclically movable along tracks 2 independently from one another.

For achieving such independent movement, each track 2 is preferably equipped with magnetic field generators, e.g. a plurality of electric coils, which, in a well-known manner, independently control the movement of each body element 3, the latter being provided with a corresponding permanent magnet unit (not shown).

In practice, each permanent magnet unit is magnetically coupled, in use, with the electric coils of the respective track 2, so that each cart assembly 1 can be independently controlled.

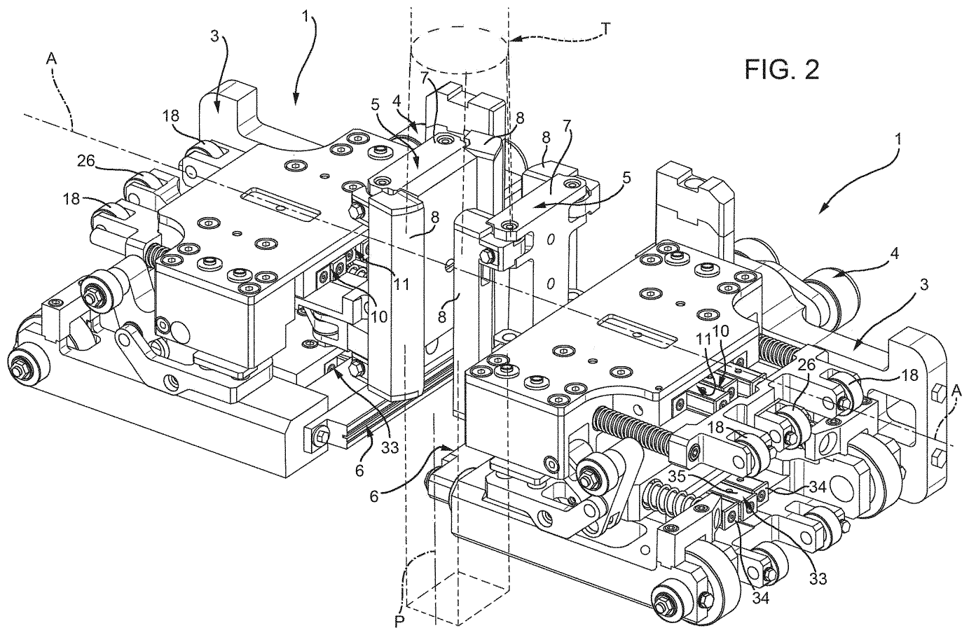

According to this non-limiting preferred embodiment shown, the conveying device is part of a packaging apparatus configured to form and seal a plurality of packs containing a pourable food product starting from a tube T (only schematically shown in FIG. 2) of packaging material. In particular, tube T is fed vertically between tracks 2 of the conveying device.

In this case, each cart assembly 1 moving on one track 2 is configured to cooperate with the corresponding cart assembly 1 moving on the other track 2 and with tube T so as to form a plurality of pillow packs and to seal the tube T at equally spaced cross-sections, or sealing bands, crosswise to each conveying path P. Furthermore, such cart assemblies 1 are configured to cooperate with tube T to cut such pillow packs along the sealing bands, in order to separate the pillow packs from one another.

With particular reference to FIG. 1, conveying paths P substantially comprise:
respective operative branches O, which are substantially rectilinear, parallel and facing each other, between which tube T is fed, and along which cart assemblies 1 cooperate with the tube T, so as to form and seal one respective prismatic pack (partially visible in FIG. 2 at the bottom end of tube T) at a time and cut the latter at the relative sealing band; and
respective return branches R, along which cart assemblies 1 are detached from tube T.

To this end, each cart assembly 1 comprises:
a first tool, preferably a forming device in the shape of a half-shell 5, configured to cooperate with tube T to form respective packs; and
a second tool, preferably a sealing device 6, configured to seal each respective formed pack at the relative sealing band.

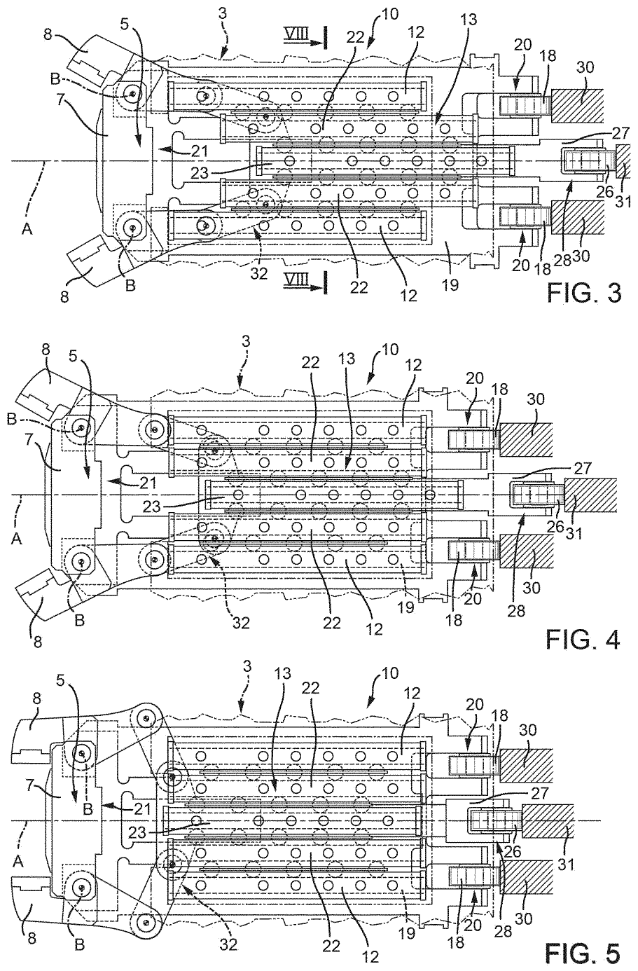

In particular, each half-shell 5 is mounted in a movable manner on body element 3 of each respective cart assembly 1 and has a substantially C-shaped cross section. In greater detail, as visible in FIGS. 2 to 7, each half-shell 5 comprises a main wall 7 and a pair of lateral flaps 8 projecting from respective opposite lateral edges of wall 7 and hinged thereon in a rotatable manner about respective axes B (FIGS. 3 to 7) parallel to wall 7. In detail, axes B are parallel to a direction A orthogonal to the operative branch O of path P when the relative cart assembly 1 moves along the operative branch O of path P.

Each sealing device 6 is mounted in a movable manner on body element 3 of each respective cart assembly 1 moving on one track 2, preferably underneath the corresponding half-shell 5, and comprises a sealing element and an extractable cutting element; each sealing device 6 of each corresponding cart assembly 1 moving on the other track 2 comprises a respective counter-sealing element and a respective seat adapted to receive one respective cutting element.

In the preferred embodiment shown, sealing elements are inductive heating elements and the corresponding counter-sealing elements are made of elastomeric material, which provides the necessary mechanical support to grip tube T to the required pressure.

In light of the above, each cart assembly 1 advances along the respective conveying path P one single half-shell 5 and one single sealing device 6, both carried in a movable manner by the respective body element 3.

In particular, such components are cyclically driven respectively on operative branches O, along which the corresponding cart assemblies 1 downwardly move parallel to tube T and are arranged on respective opposite sides thereof, and on return branches R, along which such cart assemblies 1 move away from tube T, and consequently back towards tube T again.

More specifically, when each cart assembly 1 moves along operative branch O of the respective conveying path P, the respective half-shell 5 and sealing device 6 move back and forth along direction A between:
an operative position, in which the half-shell 5 and the sealing device 6 cooperate with tube T to form and seal respective packs; and
an idle position, in which the half-shell 5 and the sealing device 6 are detached from tube T or formed packs.

In particular, when two facing half-shells 5 of a pair of cooperating cart assemblies 1 are both in their operative positions, their walls 7 and flaps 8 face each other to define a substantially prismatic cavity and accordingly control the volume and shape of the relative pack in formation.

As shown in particular in FIGS. 2 to 7, each cart assembly 1 further comprises a guide mechanism 10 configured to allow the movement of the respective half-shell 5 with respect to the relative body element 3 along direction A.

It is specified that, in the following description, reference is made to one single cart assembly 1, moving along a respective track 2 of the conveying device, and to its respective components. What is stated below is valid also for each cart assembly 1 moving on the same track 2 or the other track 2.

In particular, guide mechanism 10 of such cart assembly 1 is housed in a compartment 11 of body element 3 and comprises:
two first guide elements 12, rigidly mounted on said body element 3 and extending parallel to direction A; and
one second guide element, preferably a slider 13, connected to half-shell 5, also extending parallel to direction A, slidably coupled to both guide elements 12 and interposed between them.

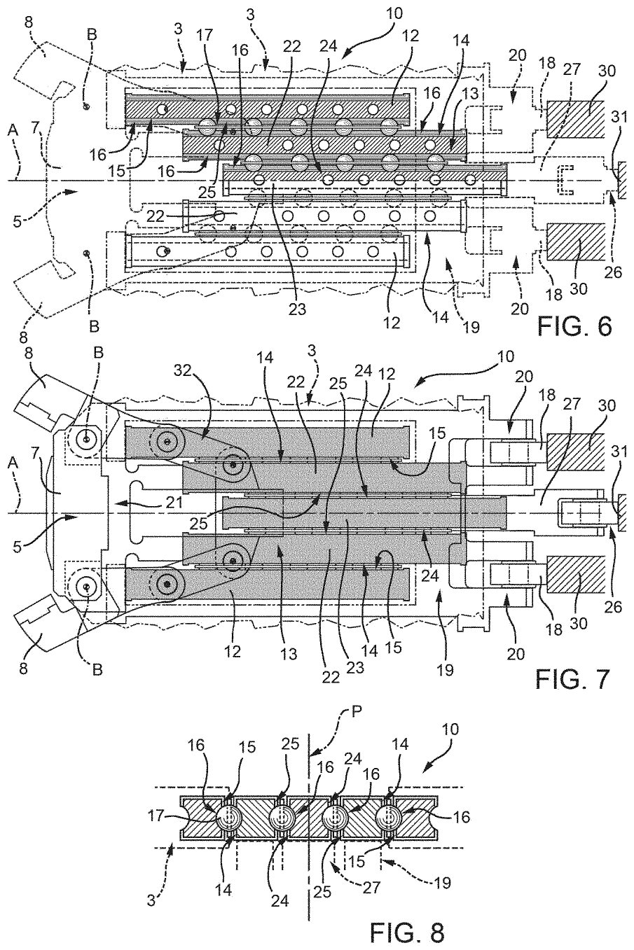

As visible in particular in FIGS. 6 to 10, slider comprises a pair of opposite lateral surfaces 14, which extend parallel to direction A and along which slider 13 cooperates with both guide elements 12.

In particular, lateral surfaces 14 of slider 13 cooperate in contact with respective lateral surfaces 15 of guide elements 12.

In greater detail, each guide element 12 comprises one lateral surface 15 facing one respective lateral surface 14 of slider 13. Furthermore, both lateral surfaces 14 and lateral surfaces 15 have a respective linear slit 16 adapted to house a low-friction element, preferably a linear bearing 17.

In practice, one linear bearing 17 is arranged between each lateral surface 15 and the facing lateral surface 14, so as to allow slider 13 to slide along direction A with respect to both guide elements 12.

As visible in FIGS. 2 to 10, cart assembly 1 further comprises actuator means configured to automatically control the movement of slider 13 along direction A.

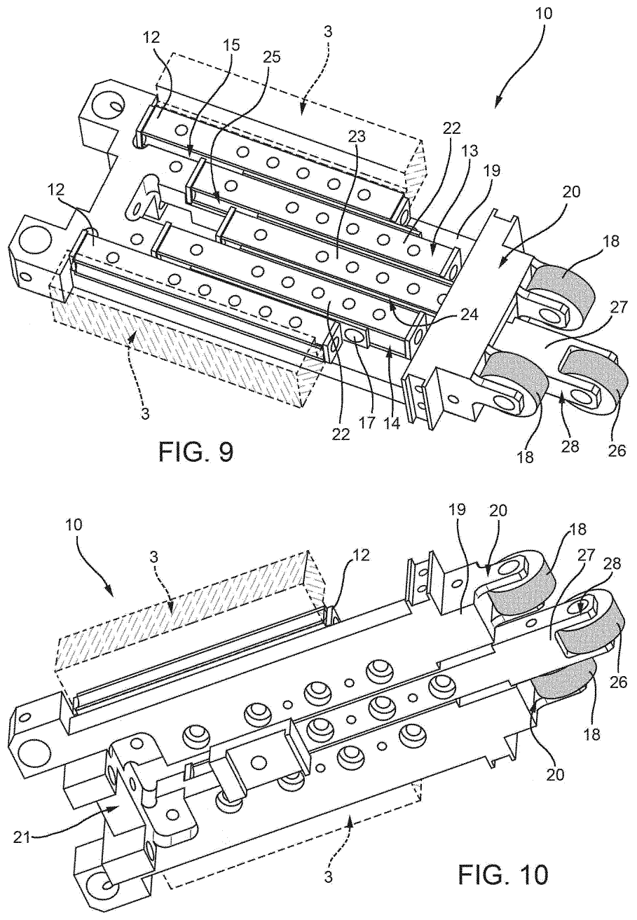

In particular, actuator means comprise:
a pair of cam surfaces 30, fixed with respect to cart assembly 1 and extending parallel to the respective operative branch O and transversally to direction A;
a pair of cam followers 18 carried by cart assembly 1 and configured to cooperate with cam surfaces 30; and
a sliding member 19 (FIGS. 9 and 10) extending parallel to direction A, underneath guide elements 12 and slider 13, and connected to cam followers 18 at a back end 20 thereof.

Furthermore, sliding member 19 carries superiorly slider 13 and further carries, at a front end 21 thereof, wall 7 of half-shell 5.

In practice, as cam followers 18 cooperate, in known manner, with different operative portions of the respective cam surfaces 30, cam followers 18 move back and forth along direction A, causing a corresponding back and forth movement of the sliding member 19 and, thus, of slider 13 along the direction A, with respect to guide elements 12.

With reference to FIGS. 2 to 10, slider 13 comprises:
two third guide elements 22, connected to wall 7 of half-shell 5 and extending parallel to direction A; and
a fourth guide element, preferably a further slider 23, connected to flaps 8 of half-shell 5, also extending parallel to direction A, slidably coupled to both guide elements 22 and interposed between them.

According to this preferred embodiment shown, guide elements 12, guide elements 22, and slider 23 are bar-shaped with a substantially square cross section. In light of the above, guide mechanism 10 has a telescopic structure provided with five bar-shaped guide elements configured to cooperate in a sliding manner with each other.

As visible in particular in FIGS. 6 to 10, slider 23 comprises a pair of further opposite lateral surfaces 24, which extend parallel to direction A and along which slider 23 cooperates with guide elements 22.

In particular, lateral surfaces 24 of slider 23 cooperate in contact with respective lateral surfaces 25 of guide elements 22.

In greater detail, each guide element 22 comprises one lateral surface 25 facing one respective lateral surface 24 of slider 23. Furthermore, both lateral surfaces 24 and lateral surfaces 25 have a respective linear slit 16 adapted to house a linear bearing 17.

In practice, a linear bearing 17 is arranged between each lateral surface 25 and the facing lateral surface 24, so as to allow slider 23 to slide along direction A with respect to both guide elements 22, in the same manner described above for slider 13 and guide elements 12.

As visible in FIGS. 2 to 10, cart assembly 1 further comprises further actuator means configured to automatically control the movement of slider 23 along direction A.

In particular, the further actuator means comprise:
a further cam surface 31, fixed with respect to cart assembly 1 and extending parallel to cam surfaces 30;
a further cam follower 26 carried by cart assembly 1 and configured to cooperate with cam surface 31; and
a further sliding member 27 (FIGS. 9 and 10) extending parallel to direction A, underneath slider 23, and connected to cam follower 26 at a back end 28 thereof.

Furthermore, sliding member 27 carries superiorly slider 23 and is connected to flaps 8 of half-shell 5 by means of a lever mechanism 32, known per se and only schematically shown insofar as necessary for the comprehension of the present invention.

In particular, lever mechanism 32 is configured to convert the movement of sliding member 27 along direction A into the rotation of flaps 8 about the respective axes B towards and away from each other.

In practice, as cam follower 26 cooperates, in known manner, with different operative portions of the respective cam surface 31, cam follower 26 moves back and forth along direction A, causing a corresponding back and forth movement of the sliding member 27 and, thus, of slider 23 along the direction A, with respect to guide elements 22.

Through lever mechanism 32, the transversal movement of slider 23 and sliding member 27 is converted into a rotational movement of flaps 8.

In such a condition, flaps 8 of half-shell 5 rotate from a position in which they diverge from wall 7 to a position in which they are substantially orthogonal to wall 7 and contact tube T to completely surround tube T.

According to the non-limiting preferred embodiment shown, cart assembly 1 also comprises a further guide mechanism 33 (only partially shown in FIG. 2) configured to allow the movement of sealing device 6 along direction A with respect to body element 3.

In particular, guide mechanism 33 comprises:
two first guide elements 34, rigidly mounted on said body element 3 and extending parallel to direction A; and
one second guide element, preferably a slider 35, connected to sealing device 6, also extending parallel to direction A, slidably coupled to both guide elements 34 and interposed between them.

It is specified that such guide mechanism 33 has similar components and operating scheme to those described above for slider 13.

In light of the above, guide mechanism 33 has a telescopic structure provided with three bar-shaped guide elements configured to cooperate in a sliding manner with each other.

The operation of cart assembly 1 is described hereafter starting from a condition in which two cart assemblies 1 move along tracks 2 respectively, following the relative conveying paths P from return branch R to operative branch O.

In this condition, each cart assembly 1 approaches the respective operative branch O, and the relative half-shell 5 and sealing device 6 start to move from their idle positions to their operative positions (FIG. 3).

In particular, when each pair of cam followers 18 cooperates with the corresponding cam surface 30, the relative sliding member 19 moves along direction A, so moving wall 7 of the respective half-shell 5 (FIG. 4). During this movement, the cooperation between guide elements 12 and slider 13 ensures an accurate and precise displacement of guide elements 12 and slider 13 along direction A.

Then, when each cam follower 26 cooperates with the respective cam surface 31, the relative sliding member 27 moves along direction A, activating the respective lever mechanism 32 and driving flaps 8 of the respective half-shell 5 (FIG. 5).

During this movement, the cooperation between guide elements 22 and slider 23 ensures an accurate and precise displacement of guide elements 22 and slider 23 along direction A. After the forming and sealing operation is completed, each half-shell 5 and sealing device 6 return to their idle positions.

It is specified that the same operation scheme to that described for the components of slider 13 applies to guide mechanism 33, with the only difference that guide elements 34 are fixed.

The advantages of cart assembly 1 according to the present invention will be clear from the foregoing description.

In particular, guide mechanism 10 and guide mechanism 33 are provided with three or five guide elements cooperating in contact with each other. More precisely, thanks to the telescopic configuration comprising three guide elements, it is possible to obtain a movement of the relative tool along direction A with the minimum number of components (three) and with the maximum structural compactness with respect to a direction orthogonal to direction A.

Furthermore, thanks to the telescopic configuration comprising five guide elements, it is possible to obtain two relative movements along direction A with the minimum number of components (five) and with the maximum structural compactness with respect to the direction orthogonal to direction A.

Moreover, with such configurations, the overall weight of cart assembly 1 is reduced as well.

Clearly, changes may be made to cart assembly 1 as described herein without, however, departing from the scope of protection as defined in the accompanying claims.

In particular, slider 13, slider 23 and slider 35 may be rigidly mounted on body element 3, so performing the proper function of guide elements, and guide element 12, guide element 22 and guide element 34 may be connected to half-shell 5 or sealing unit 6 and may move relatively to slider 13, slider 23 and slider 35, so as to perform the proper function of sliders.

1. A cart assembly for a conveying device, said cart assembly comprising a body element, movable along a conveying path and at least one tool carried by said body element in a movable manner between an operative position, in which said tool is designed to perform an operation on a given article, and an idle position, in which said tool is in a stand-by condition; said cart assembly further comprising a guide mechanism configured to allow the movement of said tool with respect to said body element; said guide mechanism comprising two first guide elements, extending parallel to a given direction, and one second guide element, also extending parallel to said direction and interposed between said first guide elements; said first guide elements and second guide element being slidably coupled so as to permit a relative movement along said direction of said second guide element, with respect to said first guide elements or vice versa;
wherein said second guide element has opposite lateral surfaces extending parallel to said direction and cooperating in contact with both said respective first guide elements.

2. The assembly as claimed in claim 1, wherein said direction is transversal with respect to a portion of said path along which said tool moves between said idle position and operative position.

3. The assembly as claimed in claim 1, wherein said lateral surfaces of said second guide element cooperate in contact with respective lateral surfaces of said first guide elements.

4. The assembly as claimed in claim 3, wherein said lateral surfaces of said first guide elements cooperate with said lateral surfaces of said second guide element by respective linear bearings.

5. The assembly as claimed in claim 1, wherein said second guide element comprises two third guide elements and one fourth guide element interposed between said third guide elements said third guide elements and fourth guide element being slidably coupled so as to permit a relative movement along said direction of said fourth guide element with respect to said third guide elements or vice versa;
said fourth guide element having opposite lateral surfaces extending parallel to said direction and cooperating in contact with both said third guide elements.

6. The assembly as claimed in claim 5, wherein said lateral surfaces of said fourth guide element cooperate in contact with respective lateral surfaces of said third guide elements.

7. The assembly as claimed in claim 6, wherein said lateral surfaces of said third guide elements cooperate with said lateral surfaces of said fourth guide element by respective linear bearings.

8. The assembly as claimed in claim 5, wherein said tool comprises a first operative portion and a second operative portion movable with respect to said first operative portion;
said third guide elements being connected to said first operative portion and said fourth guide elements being connected to said second operative portion.

9. The assembly as claimed in claim 8, wherein said first operative portion is configured to move back and forth along said direction; said second operative portion being carried by said first operative portion and comprising at least one flap rotatable about an axis transversal to said direction a long the portion of said path where said tool moves between said idle and operative positions;
said fourth guide element being connected to said flap by a lever mechanism; said lever mechanism being configured to convert the movement of said fourth guide element along said direction into the rotation of said flap about said axis.

10. The assembly as claimed in claim 1, wherein said first guide elements are rigidly mounted on said body element and said second guide element is connected to said tool.

11. A conveying device comprising at least one track and a cart assembly according to claim 1, wherein said conveying device is of linear motor type.

12. A packaging apparatus including at least one conveying device in turn comprising at least one endless track and one or more cart assemblies according to claim 1 and movable along said track; each cart assembly including at least one tool configured to cooperate with a packaging material so as to form and/or seal a plurality of respective packs for containing a pourable food product.
